(19) United States
(12) Patent Application Publication
(10) Pub. No.: US 2004/0205602 A1
(43) Pub. Date: Oct. 14, 2004

(54) Page layout design using geometric interference schema

(76) Inventor: Douglas Croeni, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/916,043

(22) Filed: Jul. 25, 2001

(51) Int. Cl. G06F 15/00

(52) U.S. Cl. 715/517; 715/530

(57) ABSTRACT

Text in a document is formatted. Bounding shapes are placed around each word in the text. A first word is situated in a first valid location within a page. Subsequent words are situated in subsequent valid locations on the page. Once any word is situated, a bounding shape for the word sets out an area invalid for additional word placement. For example, space characters are merged with a following word. The first word is placed in a first location on the page. When the first location is invalid for text, the first word is moved to a next location (i.e., additional next locations if necessary) until the first word is placed in the first valid location. A subsequent word is placed in a next location. When the next location is invalid for text, the subsequent word is moved to a next location until the subsequent word is placed in a valid location. This is repeated for each subsequent word until there are no more subsequent words to place. For example, the next location is at an end of a previous word. When an image is placed in an area occupied by placed words, the area is marked as invalid for text and the text is reformatted from the beginning. The processing text code is used, for example, to indicate which locations within the page are available for text placement. For example, the text code allows specification of a bounding shape for a block of text. The text code, for example, allows marking of areas within a page as being invalid for text placement. The text code, for example, allows marking of an area within a shape as being valid for text placement.

### BACKGROUND

The present invention pertains to formatting documents and pertains particularly to page layout design using geometric interference schema.

Various programs exist that allow users to create, transmit, and display documents in electronic form. There are several advantages electronic documents have over paper documents. These advantages include compact storage, ease of transmission, and the ability to be electronically edited. In addition to information content (such as text, graphics, and pictures), an electronic document generally includes at least some formatting information that directs how the content is to be displayed.

In order to allow a document to have a uniform appearance across multiple software platforms, “portable” formats have been developed. For example, the Portable Document Format™ (PDF™) has been developed by Adobe Systems, Inc. of Mountain View, Calif. Programs operating on a variety of different computer platforms can display, edit, print and annotate the same PDF document. This allows for a significant portability of PDF between computing systems while retaining the appearance of the document, even when utilized by several computer platforms. See for example U.S. Pat. No. 6,073,148, issued to Rowe, et al for DISPLAYING ELECTRONIC DOCUMENTS WITH SUBSTITUTE FONTS.

When creating documents, it is often desirable to integrate text and graphics. Various methods have been used to allow the integration of text and graphics. For example, word processing programs typically allow some type of word wrap around images. Web browsers contain similar features. However, the methods used to perform integration of text and graphics is often very complex and difficult to implement efficiently.

### SUMMARY OF THE INVENTION

In accordance with the preferred embodiment of the present invention, text in a document is formatted. Bounding shapes are placed around each word in the text. A bounding shape is a geometric definition of the space that the word requires for proper placement of the word on the page. For example, bounding shapes can be rectangular bounding boxes. A first word is situated in a first valid location within a page. Subsequent words are situated in subsequent valid locations on the page. Once any word is situated, a bounding shape for the word sets out an area invalid for additional word placement.

For example, space characters are merged with a following word. A first location on the page is checked for placement of the first word. When the first location is invalid for text, a next location (i.e., additional next locations if necessary) are checked until the first word is placed in the first valid location.

A next location is checked for placement of a subsequent word. When the next location is invalid for text, next locations are checked until the subsequent word is placed in a valid location. This is repeated for each subsequent word until there are no more subsequent words to place. For example, the next location is at an end of a previous word.

When an image is placed in an area occupied by placed words, the area is marked as invalid for text and the text is reformatted from the beginning. The area marked invalid is defined by a bounding shape for the image

In the preferred embodiment, processing text code is used. The processing text code indicates, for example, which locations within the page are available for text placement. For example, the text code allows specification of a bounding shape for a block of text. The text code, for example, allows marking of areas within a page as being invalid for text placement. The text code, for example, also allows marking of an area within a shape as being valid for text placement.

The present invention provides for a simple and elegant way of formatting text, for example for placement in PDF files.

### BRIEF DESCRIPTION OF THE DRAWINGS

FIG. 1 is a flowchart that illustrates a method for providing page layout of text and graphics in accordance with a preferred embodiment of the present invention.

FIG. 2 is a flowchart that illustrates placement of text in accordance with a preferred embodiment of the present invention.

FIG. 3 is a simplified block diagram showing the layout of four pages of text resulting from text code prepared and executed in accordance with a preferred embodiment of the present invention.

FIG. 4 is a flowchart that illustrates placement of text within a shape in accordance with a preferred embodiment of the present invention.

FIG. 5 is a simplified block diagram showing text within a shape placed as per the logic illustrated within the flowchart shown in FIG. 4 in accordance with a preferred embodiment of the present invention.

FIG. 6 is a simplified block diagram showing bounding shapes placed around words of text in accordance with a preferred embodiment of the present invention.

### DESCRIPTION OF THE PREFERRED EMBODIMENT

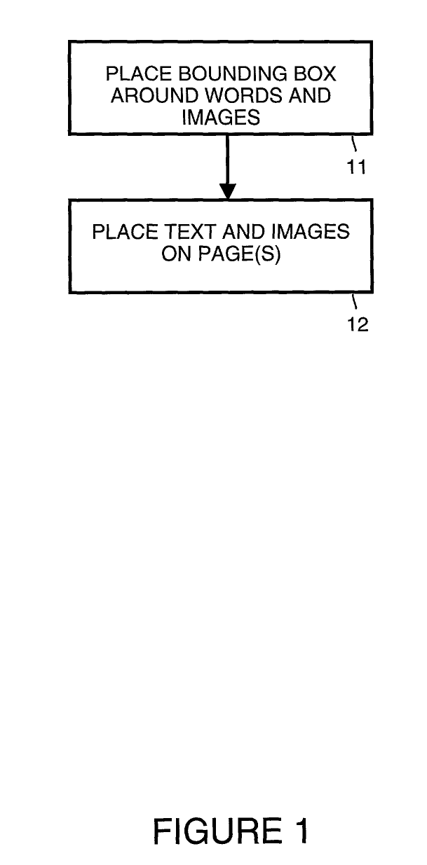

FIG. 1 is a flowchart that illustrates a method for providing page layout of text and graphics. In a step 11, a bounding shape is defined for every word. A bounding shape is a geometric definition of the space that the word requires for proper placement of the word on the page. Space characters are merged with the following word. Images, when placed, also have a bounding shape. As illustrated by a step 12, images and text are then placed on one or more pages. When an image is placed on a page, the region covered by the bounding shape for the image is marked as invalid for the placement of text.

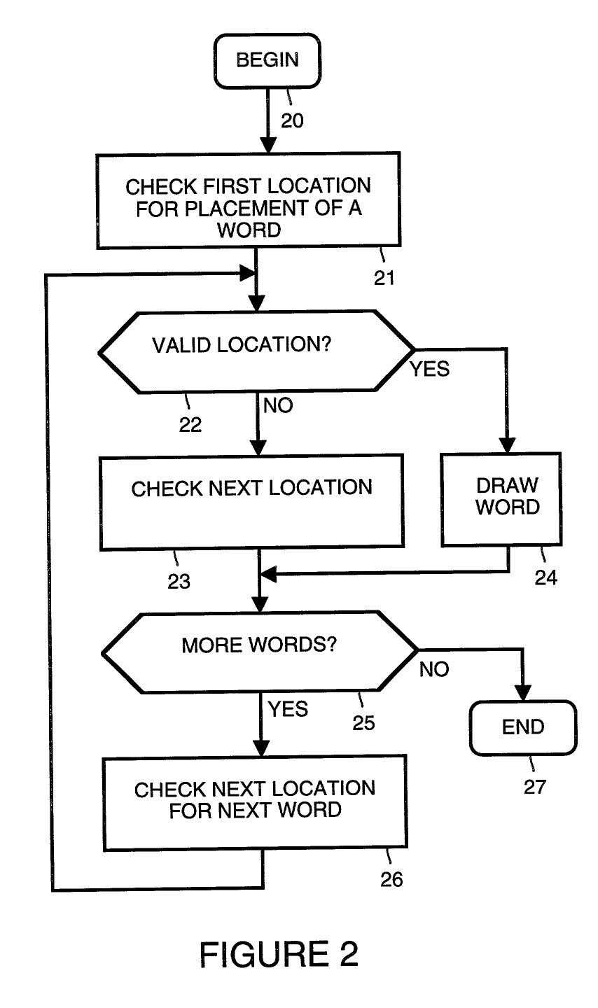

FIG. 2 is a flowchart that illustrates placement of text. In a step 20, text placement begins. In a step 21, a first location is checked for placement of a word. For example, the first location on the page is the upper left hand corner of the paper. Alternatively, default horizontal alignment can be left or right margin. Also, as explained further below, text can be placed in particular areas, for example within bounding shapes set aside for blocks or text.

In a step 22, a determination is made as to whether the location is a valid location for the word. If so, in a step 24, the word is drawn at the location. The area occupied by the bounding shape of the word is marked invalid for further text placement.

If in step 22 the location is not a valid location, in a step 23, a next location is checked for placement of the word. For example, the next location is one point (1/72 inch) to the right. If the previous location is at the right edge of the page, the next location to test is on the next line at the leftmost edge of the page.

If in step 25 there are more words, in a step 26 a next location is checked for placement of a next word. In this case, the next location is at the end of the previous word. If the previous location is already at the right edge of the page, the next location is on the next line at the leftmost edge of the page.

If in step 25 there are no more words, in a step 27 placement of text is completed. This procedure for placing text allows for text wrap around arbitrary geometric shapes.

If after beginning to place text an image appears in the text, the bounding shape for the image is marked as invalid for the placement of text. In this case, placement of text is restarted from the beginning. Restart is required because the image may have made a region with text into an invalid region for text.

The present invention is embodied, for example using text code with features set out in Table 1 below:

TABLE 1
Declare the style of the current document.

| | | |
|---|---|---|
| name | string | The name of a java Style class, which is |
| | | then dynamically loaded. All tags are |
| | | redirected to and processed by this |
| | | class. |
| optional | string, | Any extra information passed to the |
| | float | style class should be declared in the |
| | | style tag. |

<body></body>, <header></header>, <footer></footer>
Layout text with formatting and embedded images.

| | | |
|---|---|---|
| fontsize | Float | Default font settings |
| fontname | String | |
| leading | Float | Default line spacing |
| indent | Float | Default paragraph indent. The indent |
| | | value is multiplied by the width of one |
| | | lowercase “m” in the current font. |
| x | Float | The bounding shape for this block of |
| y | | text. The defaults for these attributes |
| width | | are provided by the Style of the |
| height | | document. |
| bgcolor | Six-digit | “#000fff”, “000fff” are both acceptable. |
| | hexadeci-mal | See also: font color constants. |
| page | Int (comma- | HEADERS AND FOOTERS ONLY. The |
| | separated | page number on which the |
| | list) | header/footer will appear. Acceptable |
| | | values consist of a comma-separated |
| | | list of single integers or range (3-12). If |
| | | no page is specified, the header/footer |
| | | will appear on every page unless |
| | | otherwise “overwritten”. Internally, this |
| | | default is represented as page 0. |

<p></p>
Begin a new paragraph.

| | | |
|---|---|---|
| indent | float | Override the document default indent. |
| | | Unlike the default, this indent is straight point |
| | | size. |
| Imargin | float | Move in the left margin. This moves the |
| | | bounding shape of this block until </p> sets it |
| | | back. |
| rmargin | float | Move in the right margin. |
| linebreak | Boolean | If true, causes a linebreak when the <p> is |
| | | encountered. If linebreak is not specified in |
| | | the tag, it's default is true. |
| align | “left” | Set the justification for the text. The default is |
| | “right” | left. |
| | “center” | |
| | “justify” | |
| keep | “together” | Specify how much of this paragraph must be |
| | “next” | kept on the same page. If “together”, the |
| | “off” | entire paragraph must be kept all on one |
| | int | page. If “next”, the paragraph must be kept |
| | | together in addition to satisfying the keep |
| | | properties of the next paragraph. If the value |
| | | is some int, that number of lines must be on |
| | | the same page. |
| | | The default keep behavior is “2” (which acts |
| | | as an orphan control). Use the value “off” or |
| | | “0” to turn off all keep behavior. |
| <img/> | | |

Place an image.

| | | |
|---|---|---|
| src | string | Name of an the image. If this image |
| | | cannot be found, a default will load in its |
| | | place. May be on the local file system or |
| | | an URL, in which case the file will be |
| | | downloaded and stored temporarily. |
| x | float | Bounding shape for the image. Setting x |
| y | | or y sets halign or valign to FIXED, |
| width | | respectively. |
| height | | Defaults: the current x, y position and the |
| | | image's width and height. |
| halign | “left” “right” | Align the image horizontally. “fixed ” will |
| | “center” | leave the image at the x location it was |
| | “fixed” | encountered. The default is right or left, |
| | | selected by whichever it is closest to at the |
| | | time. |
| valign | “top” | Align the image vertically with respect to |
| | “center” | the baseline of the current text position. |
| | “bottom” | “top” puts the top of the image on the |
| | “fixed” | baseline. “bottom” puts the bottom of the |
| | | image on the baseline. “fixed” will not do |
| | | any adjustment. Default is center. |
| scale | Boolean | If true, the image will resize itself to take |
| | | the largest possible area, keeping its |
| | | present ratio. If false, the image will |
| | | squash and stretch. Default is true. |
| shape | “rectangle” | Specify the shape of the images bounds to |
| | “ellipse” | allow text to flow around it. Default is |
| | | rectangle. |
| margin | float | Specify a border around the image - |
| | | essentially expanding its bounding shape. |
| | | This doesn't affect the x, y location. |
| disable_{—} | Boolean | If false, this image will not be allowed to sit |
| fit | | on top of another image. If true, a check |
| | | isn't done. Default is false. |
| z | “first” | Beginning with zero and ending with |
| | “last” | MAX_INT, the order in which images are |
| | positive int | rendered. Ties are broken by the order in |
| | | which they appeared in the document. |
| | | “first” = 0, “last” = MAX_INT, default = 1. |
| persist | Boolean | An image outside of a body context can |
| | | persist - so that it continues to appear on |
| | | new pages. |
| overwrite | Boolean | if false, text will not be allowed to write over |
| | | this image |

<textimage/>
Create an image out of a block of text.

| | | |
|---|---|---|
| value | string | Text string to be displayed. |
| mode | “left” | Align text. See PDFlib Reference p.74 |
| | “right” | |
| | “center” | |
| | “justify” | |
| | “fulljustify” | |
| name | string | Font name. Default is the current context. |
| size | float | Font size. Default is the current context. |
| color | six-digit | “000fff”, “#000fff” both acceptable formats. |
| | hexadecimal | Default is the current context. See also: |
| | | font color constants. |

Notes:
All attributes that apply to <img> apply to <textimage>, with the
following exceptions:
The src attribute should not be used.
The default width is the stringwidth of the current font.
The default height is the current font size. (Setting the height to less than
the font size will cause no text to be drawn).
<font></font>
Change the current font.

| | |
|---|---|
| name | string |
| size | float |

| | | |
|---|---|---|
| color | six-digit | “000fff”, “#000fff” both acceptable formats. |
| | hexadecimal | Also: “white”, “black”, “lightgray”, “gray”, |
| | | “darkgray”, “red”, “blue”, “green”, “pink”, |
| | | “orange”, “yellow”, “magenta”, “cyan”. |

Notes:
The three font attributes are independent of each other. The <font> tag
can be nested.
<ol></ol>, <ul></ul>
Create a list, ordered or unordered.

| | | |
|---|---|---|
| startvalue | int | In an ordered list, the number to start |
| | | from. Default is 1. |
| indent | float | Indent space specified in points. |
| keep | “together” | Specify how much of this list should be |
| | int | kept on the current page. “together” |
| | | keeps the whole list on one page. An int |
| | | keeps that number of list elements on the |
| | | current page. |
| <li></li> | | A list element. |

Notes:
A list element will never be broken across a page.
<br/>
Line break.

| | | |
|---|---|---|
| size | float | Specify the point size to move down the page. |
| | | First, a normal font size break will occur, then |
| | | if the size is larger than this break, the |
| | | current y position will move down the |
| | | difference. |

<define/>
Define a constant for later use.

| | | |
|---|---|---|
| name | String | Name of the defined constant. To refer to this |
| | | definition, where “constant” is the name, use |
| | | “$constant”. The special character signals |
| | | special processing. |
| value | float | Point size value that the constant will be |
| | | substituted for. Forward references are not |
| | | allowed, but it is possible to use previously |
| | | defined terms in a simple expression. |
| | | Example: |
| | | <define name = “constant2” |
| | | value = “$constant * 2”> |

Notes:
$height and $width are predefined constants representing page height and
page width. These constants can be substituted for numerical values in a
tag. Simple expressions involving +, −, *, and / are allowed also.
Example:
<img src = “an_image” x = “$width/2” y = “($height * .01) + 20)”>
<mark/>
Place a mark in the text which can be referred to after the document is
generated

| | | |
|---|---|---|
| id | String | Set a key with a value of the current page |
| | | number. |

<border/>
Place a border around a given rectangle.

| | | |
|---|---|---|
| image | String | Image filename to be tiled. A side-effect |
| | | of specifying an image is that a white |
| | | rectangle is drawn inside of the border. |
| | | “image” and “color” are exclusive |
| | | attributes. |
| thickness | float | Point size thickness of the border. |
| x | float | Specify the rectangle for this border. |
| y | | The default values are x = 0, y = 0, width = |
| width | | (page width), height = (page height). |
| height | | |
| color | six-digit | “#000fff”, “000fff” are both acceptable. |
| | hexadecimal | See also: font color constants. A colored |
| | | border does not have the same side- |
| | | effect as an image. “image” and “color” |
| | | are exclusive attributes. |
| persist | Boolean | If true, the border appears on all new |
| | | pages. Default is true. |

<newpage/>
Create a new page. (Must appear outside of a <body> tag).

| | | |
|---|---|---|
| page | int | Specify the page number for the new page. |
| clear | Boolean | If true, clears all persistent objects: headers, |
| | | footers, borders, and persistent images. |

Other tags:

| | |
|---|---|
| <t> | replaced with five space characters (not very |
| | useful, and may soon be changed and/or |
| | removed) |
| <b></b> | bold |
| <i></i> | italic |
| <center></center> | Center text. <center> causes a linebreak if |
| | the first word after the tag is not the first |
| | word on the line. </center> causes a line |
| | break. The above also applies for <right> |
| | and <justify>. |
| <right></right> | Right justify text. |
| <justify></justify> | Full justify text. Justification is done by |
| | tweaking the length of the space character. |
| | If this space is larger than one “m”, |
| | justification is not done. |

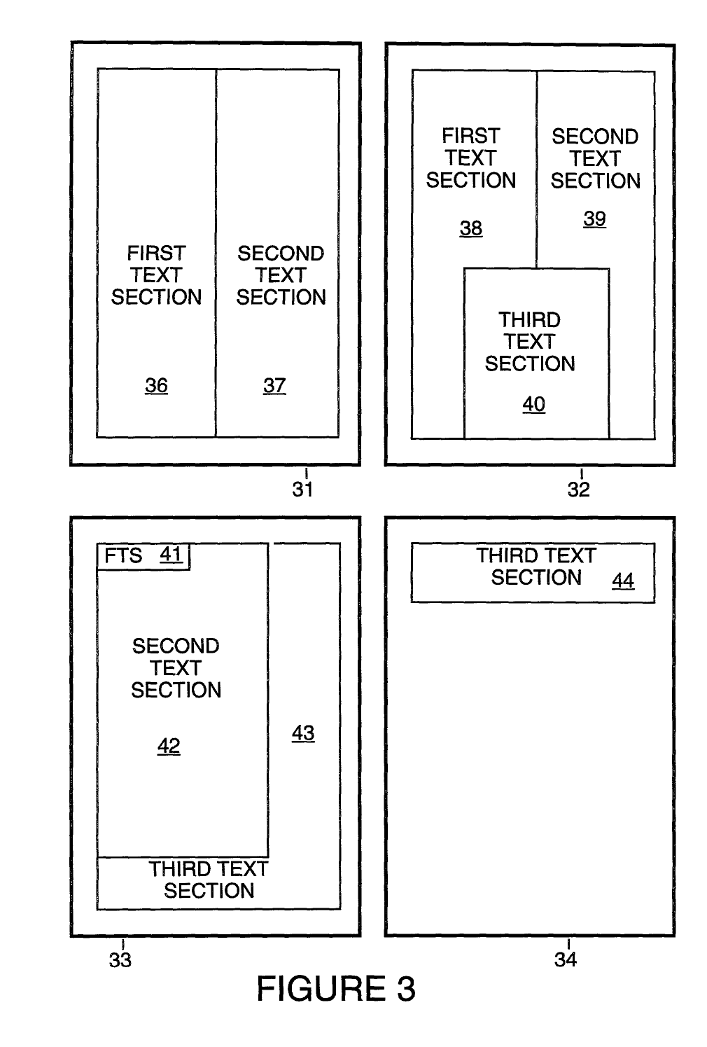

FIG. 3 is a simplified block diagram showing the layout of four pages of text resulting from text code and text sections set out in Table 2 below.

TABLE 2

```
<header><right>$page</right></header>
<body width = “($width − 72) / 2” leading = 5 overflow = “2.1”>
<font size = “14”>
          FIRST TEXT SECTION
</font>
</body>
<body leading = 5 overflow = “2.2”>
<font size = “14” color = green>
          SECOND TEXT SECTION
</font>
</body>
<newpage>
<body x = “$width/2 − 144” width = 288 y = 36 height = 400
leading = 5
          overflow = “3.3”>
<font size = “14” color = “magenta”>
          THIRD TEXT SECTION
</body>
<body name = “2.1” overflow = “3.1” width = “($width − 72) /
2”></body>
<body name = “2.2” overflow = “3.2”></body>
<newpage>
<body name = “3.1” width = “$width/3”></body>
<body name = “3.2” width = “$width * (2/3)”5</body>
<body name = “3.3”></body>
```

In FIG. 3, the first text section is shown printed out in a text area 36 of a page 31, a text area 38 of a page 32 and a text area 41 of a page 33. The second text section is shown printed out in a text area 37 of page 31, a text area 39 of page 32 and a text area 42 of page 33. The third text section is shown printed out in a text area 40 of page 32, a text area 43 of page 33 and a text area 44 of page 34.

The text code in Table 2 and the output shown in FIG. 3 demonstrate how <body> areas can be used on multiple pages and how <body> areas coordinate with each other. The text in this example (first text section, second text section and third text section) is filler text. As can be seen from Table 2, the colors of each text section is different so that in an actual print out it would be clear how the text flows between text areas of different pages.

First page 31 shows the first text section being within text (<body>) area 36 beginning at the left margin and covering half the width of page 31 (<body width=“($width−72) 2”).

The second text section is (in Table 2) assigned <body> area with the full width of the page. However, text section area 36 on page 31 contains part of the first text section and is thus an “invalid” area for additional text. When the second text is placed, the second text section cannot sit on top of the first text section. Thus, second text section is placed in text section area 37 giving page 31 the look of being printed in two columns.

In second page 32, the third text section is inserted into a rectangle area 40 in the bottom center of the page (<body x=“$width/2−144” width=288 y=36 height=400). Area 38 is used to house the first text section and is described similarly as for page 31 (<body name=“2.1” overflow=“3.1” width=“($width−72)/2”>); however, part of area 38 is unavailable for additional text placement because of text placed in area 40. Part of area 39, used to house the second text section, is also unavailable for additional text because of text placed in area 40.

In third page 33, a three column layout is set out (<body name=“3.1” width=“$width/3”></body>; <body name=“3.2” width=“$width*(2/3)”></body>; <body name=“3.3”></body>). However, on third page 33, text for the first text section and text for the second text section runs out. As can be seen on page 33, first text section (FTS) area 41 bounds only the existing text. After text for the first text section runs out, text for the second text section expands to the left margin. After text for the second text section runs out, text for the third text section expands to the left margin.

The fourth page shows the default behavior. For the third page no “overflow” is specified. Therefore, because there is still text for the third text section, a new page is created and on the new page, the most recent <body> area for the third text section is repeated.

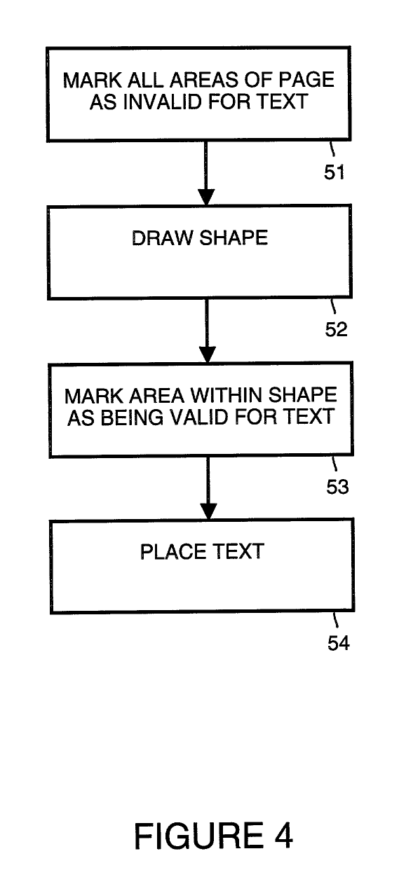

FIG. 4 is a flowchart that illustrates placement of text within a shape. In a step 51, all areas of a page are marked invalid for text. In a preferred embodiment of the present invention, step 51 is unnecessary because all areas of a page are initially marked invalid for text until a region is marked for receiving text. In a step 52, a shape is drawn. In a step 53, area within the shape is marked as being valid for text. In a step 54, text is placed.

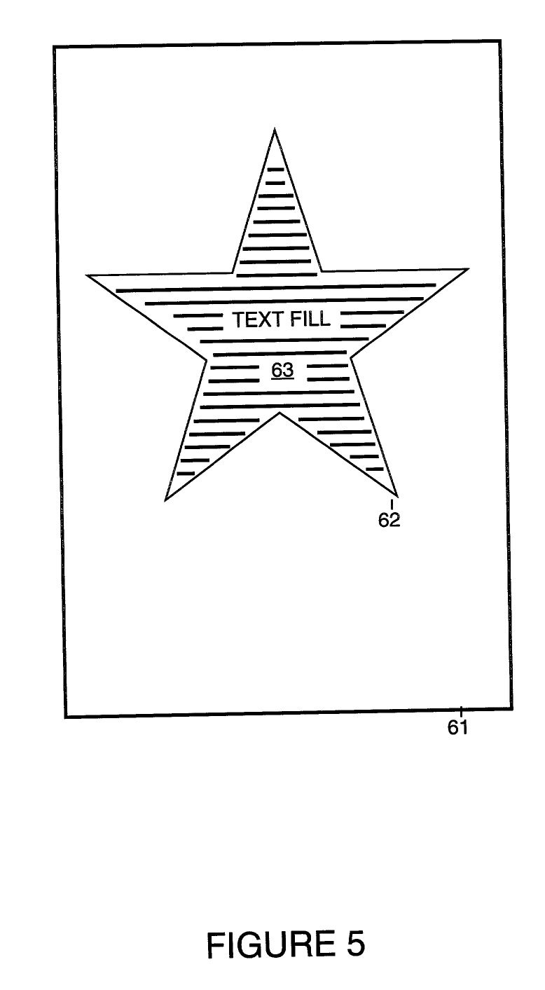

The result is shown in FIG. 5. In FIG. 5, a star 62 is the shape drawn on a page 61. Since the only valid place for text is within star 62 the text fill 63 is placed within star 62. The lines within star 62 represent lines of text that fill the area within star 62.

FIG. 4 and FIG. 5 demonstrate how valid and invalid areas can be utilized for arbitrary shapes. Since the entire area of page 61 was initially marked invalid for text, and star 62 was subsequently marked valid for text, the only location within page 61 that text can be placed is within star 62.

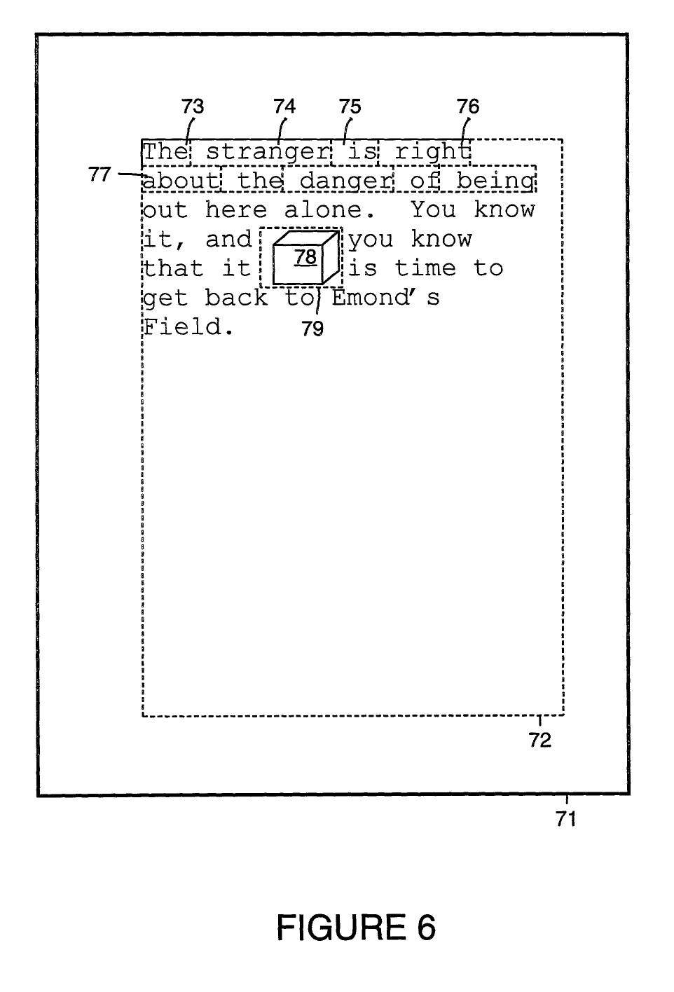

FIG. 6 is a simplified block diagram showing bounding shapes placed around words of text. Within a page 71, margins 72 set out an area valid for text placement. A bounding box 73 is placed around the word “The”. A bounding box 74 is placed around the word “stranger” and the space preceding the word “stranger”. A bounding box 75 is placed around the word “is” and the space preceding the word “is”. A bounding box 76 is placed around the word “right” and the space preceding the word “right”. A bounding box 77 is placed around the word “about”. Since there is no room within margins 72 to place bounding box 77 on the first line of text, bounding box 77 is placed on the second line of text. Additional bounding boxes are shown placed around the words “the”, “danger”, “of” and “being”. The remaining words shown on page 71 also have bounding boxes which are not shown.

FIG. 6 also shows an image 78 that was placed in an area occupied by placed words. The area was marked invalid for text and the text was reformatted after marking invalid the area defined by a bounding shape 79 for image 78.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A method for formatting text in a document comprising the following steps:
(a) placing bounding shapes around each word in the text;
(b) situating a first word in a first valid location within a page; and,
(c) situating subsequent words in subsequent valid locations on the page, wherein once any word is situated a bounding shape for the word sets out an area invalid for additional word placement.

2. A method as in claim 1 wherein step (a) includes the following substep:
(a.1) merging space characters with a following word.

3. A method as in claim 1 wherein step (b) includes the following substeps:
(b.1) checking a first location on the page for placement of the first word, and
(b.2) when the first location is invalid for text, checking a next location until the first valid location is found for placement of the first word.

4. A method as in claim 1 wherein step (c) includes the following substeps:
(c.1) checking a next location for placement of a subsequent word;
(c.2) when the next location is invalid for text, checking a next location until a valid location is found for placement of the subsequent word; and,
(c.3) repeating substep (b.1) and substep (b.2) for additional subsequent words until there are no more subsequent words to place.

5. A method as in claim 1 additionally comprising the following step:
(d) when an image is placed in an area occupied by placed words, marking the area invalid for text and reformatting the text by repeating steps (b) and (c), the area marked invalid being defined by a bounding shape for the image.

6. A method as in claim 1 additionally comprising the following step performed before step (b):
(d) processing text code that indicates which locations within the page are available for text placement.

7. A method as in claim 6 wherein in step (d) the text code allows specification of a bounding shape for a block of text.

8. A method as in claim 6 wherein in step (d) the text code allows marking of areas within a page as being invalid for text placement.

9. A method as in claim 6 wherein in step (d) the text code allows marking of an area within a shape as being valid for text placement.

10. A method as in claim 1 wherein step (c) includes the following substeps:
(c.1) checking a next location for placement of a subsequent word, the next location being at an end of a previous word,
(c.2) when the next location is invalid for text, checking a next location for placement of the subsequent word until a valid location for placement of the subsequent word is found, and
(c.3) repeating substep (b.1) and substep (b.2) for additional subsequent words until there are no more subsequent words to place.

11. A method for formatting text in a document comprising the following steps:
(a) placing bounding shapes around each word in the text;
(b) checking a next location for placement of a word;
(c) when the next location is invalid for text, checking a next location until a valid location for placement of the word is found; and,
(d) repeating step (b) and step (c) for subsequent words until there are no more words to place, wherein once any word is situated a bounding shape for the word sets out an area invalid for additional word placement.

12. A method as in claim 11 wherein step (a) includes the following substep:
(a.1) merging space characters with a following word.

13. A method as in claim 11 additionally comprising the following step:
(e) when an image is placed in an area occupied by placed words, marking the area invalid for text and reformatting the text by repeating steps (b), (c) and (d), the area marked invalid being defined by a bounding shape for the image.

14. A method as in claim 11 additionally comprising the following step performed before step (b):
(e) processing text code that indicates which locations within the page are available for text placement.

15. A method as in claim 14 wherein in step (e) the text code allows specification of a bounding shape for a block of text.

16. A method as in claim 14 wherein in step (e) the text code allows marking of areas within a page as being invalid for text placement.

17. A method as in claim 14 wherein in step (e) the text code allows marking of an area within a shape as being valid for text placement.

18. A method as in claim 11 wherein when performing step (b) for subsequent words, the next location is at an end of a previous word.

19. Storage media that stores software which when executed performs a method for formatting text in a document comprising the following steps:
(a) placing bounding shapes around each word in the text;
(b) checking a next location for placement of a word;
(c) when the next location is invalid for text, checking next locations until a valid location is found for placement of the word, wherein once any word is placed a bounding shape for the word sets out an area invalid for additional word placement; and,
(d) repeating step (b) and step (c) for subsequent words until there are no more words to place.

20. Storage media as in claim 19 wherein the method additionally comprises the following step performed before step (b):
(e) processing text code that indicates which locations within the page are available for text placement.
